(19) United States
(12) Patent Application Publication
(10) Pub. No.: US 2022/0321525 A1
(43) Pub. Date: Oct. 6, 2022

(54) INTERNET PROTOCOL VERSION 4 ADDRESS LEAF BLOCK IDENTIFICATION

(71) Applicant: AT&T Intellectual Property I, L.P., Atlanta, GA (US)

(72) Inventors: Xiaowen Mang, Morganville, NJ (US); Anestis Karasaridis, Jersey City, NJ (US)

(21) Appl. No.: 17/222,456

(22) Filed: Apr. 5, 2021

(51) Int. Cl. H04L 29/12

(52) U.S. Cl. CPC H04L 61/2046; H04L 61/6068; H04L 61/2061

(57) ABSTRACT

The disclosed technology is directed towards locating Internet Protocol version 4 (IPv4) address blocks that are not supernets to subnet address blocks. A list of IPv4 address blocks is first processed to determine supernet/subnet relationships across octets, to remove the supernets and provide a reduced list. The reduced list is iteratively processed in descending prefix length order to identify candidate supernets at each prefix length, determine which of the candidate supernets are actual supernets, remove the actual supernets, and move the remaining candidates to a leaf list. At the end of the iterations, the leaf list contains the IPv4 address blocks that do not have subnets (are not supernets).

### TECHNICAL FIELD

The subject application relates to Internet Protocol version 4 (IPv4) address blocks, and related embodiments.

### BACKGROUND

Internet Protocol version 4 (IPv4) addressing is a widely used protocol used to assign addresses to devices on a network. IPv4 addresses are 32-bit values, corresponding to approximately 4.3 billion possible addresses, and thus are becoming depleted as Internet usage continues to expand. A more recent protocol is IPv6, which coexists with IPv4 on the Internet, and which was developed in part because of the depletion of IPv4 addresses. Notwithstanding the eventual superseding of IPv4 with IPv6, IPv4 addressing will remain in use for a relatively long time.

The shortage of available IPv4 addresses has made them a valuable asset, and indeed IPv4 addresses are traded and sold. Thus, efficiently managing and/or monetizing unused IPv4 addresses is beneficial to enterprises that own them.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 is a block diagram illustrating an example system that can identify Internet Protocol version 4 (IPv4) address blocks corresponding to leaf nodes in the IPv4 hierarchical structure, in accordance with various aspects and embodiments of the subject disclosure.

FIG. 2 is an example block diagram representation of a two-tiered process for identifying address blocks corresponding to leaf nodes in the IPv4 hierarchical structure across octet boundaries and within octet boundaries, in accordance with various aspects and embodiments of the subject disclosure.

FIG. 3 is an example block diagram representation of a first tier for eliminating supernets across octet boundaries, in accordance with various aspects and embodiments of the subject disclosure.

FIG. 4 is an example block diagram representation of a second tier for eliminating supernets within octet boundaries, in accordance with various aspects and embodiments of the subject disclosure.

FIGS. 5 and 6 comprise a flow diagram of operations for eliminating supernets across octet boundaries, in accordance with various aspects and embodiments of the subject disclosure.

FIGS. 7-9 comprise a flow diagram of operations for eliminating supernets within octet boundaries, in accordance with various aspects and embodiments of the subject disclosure.

FIG. 10 illustrates example operations related to outputting a leaf dataset of IPv4 address blocks corresponding to leaf nodes in the IPv4 hierarchical structure, in accordance with various aspects and embodiments of the subject disclosure.

FIGS. 11 and 12 illustrate example operations related to determining a leaf dataset of IPv4 address blocks from an initial dataset of IPv4 address blocks, in accordance with various aspects and embodiments of the subject disclosure.

FIG. 13 illustrates example operations related to identifying IPv4 address blocks that are supernets of subnets across octet boundaries, in accordance with various aspects and embodiments of the subject disclosure.

FIG. 14 illustrates an example block diagram of an example computer/machine system operable to engage in a system architecture that facilitates wireless communications according to one or more embodiments described herein.

### DETAILED DESCRIPTION

The technology described herein is generally directed towards an Internet Protocol version 4 (IPv4) address discovery technology that efficiently identifies and reports IPv4 subnets (sub-blocks) that do not have subnets hierarchically beneath them, that is, to identify which IPv4 address blocks are not supernets (superblocks). To this end, the technology described herein takes IPv4's binary hierarchical structure nature into considerations and effectively finds the subnets that are leaf nodes in the hierarchy, which can indicate that those subnets are assigned to a dedicated customer.

Note that an internet service provider's IPv4 address blocks (assigned by the Internet Registry) can be referred to as origin blocks, which can be divided into smaller blocks used for a variety of services and infrastructures. Because of the binary, hierarchical nature of an IPv4 structure, the larger IPv4 address blocks are the supernets relative to the smaller IPv4 address subnets hierarchically below the referred supernets. A supernet has an IPv4 address prefix range that encompasses the IP address ranges of the subnets; (e.g., using classless inter-domain routing notation, a supernet with a prefix of “/13” has a subnet with a prefix of “/14” and so on).

One task that serves as a building block for any IP address planning, re-assignment and/or or monetization is to identify which IP address blocks are the leaf blocks that do not have any subnets in the same list and are thus assigned to designated customers. However, due to the sheer volume of IP address blocks, the process to find those leaf blocks can be computationally very expensive. For example, using a simple brute force method to parse through a million IPv4 address blocks is straightforward, but can take on the order of several months to even years. Instead, the technology described herein leverages the hierarchical structure of IPv4 addresses and a multi-tiered system to reduce the time to find leaf blocks to hours, e.g., approximately forty-five hours in one implementation.

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

As used in this disclosure, in some embodiments, the terms “component,” “system” and the like are intended to refer to, or include, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

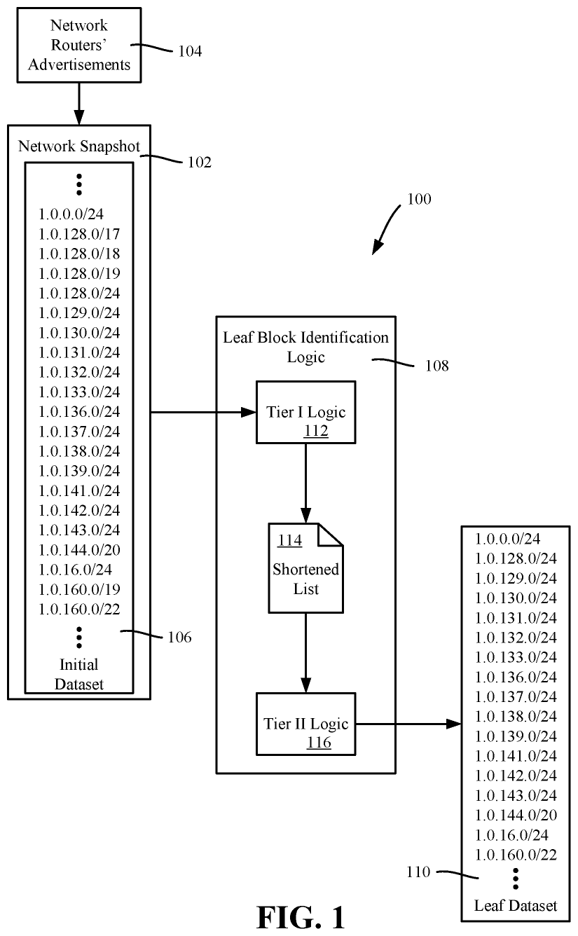

As shown in the example system 100 of FIG. 1, a network snapshot 102 is obtained by the system 100, such as in the form of a list of an internet service provider's address blocks under an origin block. The network snapshot 102 can be obtained based on information exported from route advertisements 104 of network routers.

As described herein, the network snapshot 102 can comprise the initial dataset 106 that is processed by leaf block identification logic 108 into a leaf dataset 110, such as a list data structure identifying which of the IP blocks are the leaf blocks that do not have any subnets in the same list and are thus assigned to designated customers. The leaf block identification logic 108 can be incorporated into an IP address management (IPAM) tool, or can be a standalone product, for example.

In one implementation described herein, the leaf block identification logic 108 comprises a two-tier elimination technology, in which tier I logic 112 identifies conditions for establishing definite supernet/subnet relationships across octet boundaries. In general, the processing by the tier I logic 112 results in a reduced dataset 114 by removing the identified cross-octet supernets as described herein. The reduced dataset 114 is further processed by Tier II logic 116, which in the example implementation is generally comprised of two processes, namely identification and confirmation. The identification process identifies conditions for establishing candidate (possible) supernet/subnet relationship within each octet; the confirmation process is invoked to examine the identified candidate subsets, which is a shortened list, to locate the supernets therein while building a leaf list at each hierarchical level from prefix length “/32” to prefix length “/9”.

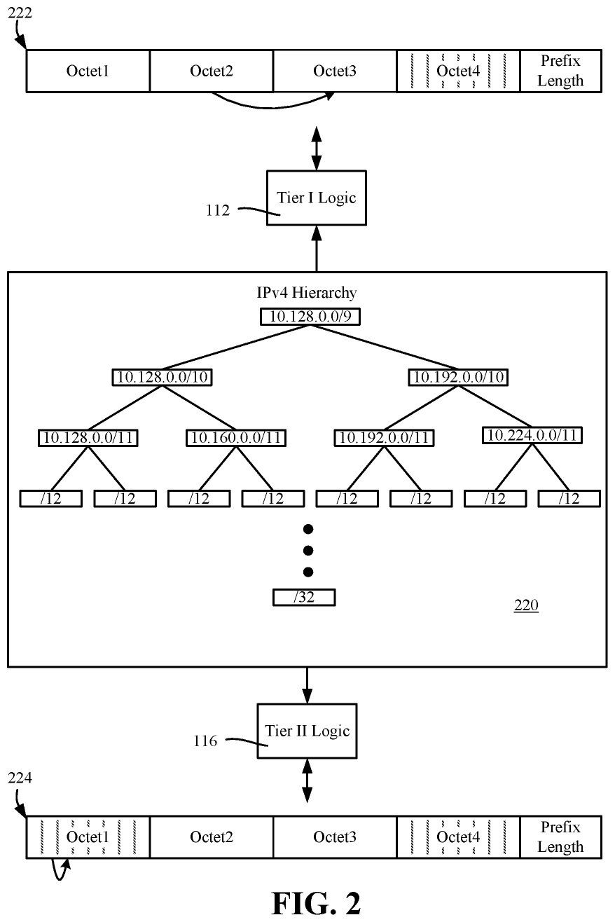

As generally represented in the IPv4 hierarchical structure 220 of FIG. 2, an IP address is a 32-bit value that is divided into four octets, e.g., “10.128.0.0/10” is an IPv4 block in classless inter-domain routing notation, where 97.128.0.0 represents the IPv4 address (in decimal values, with the decimal points “.” representing the octet boundaries) and “/10” represents its associated routing prefix length. As represented by the block labeled 222, the tier I logic 112 detects supernets across octet boundaries.

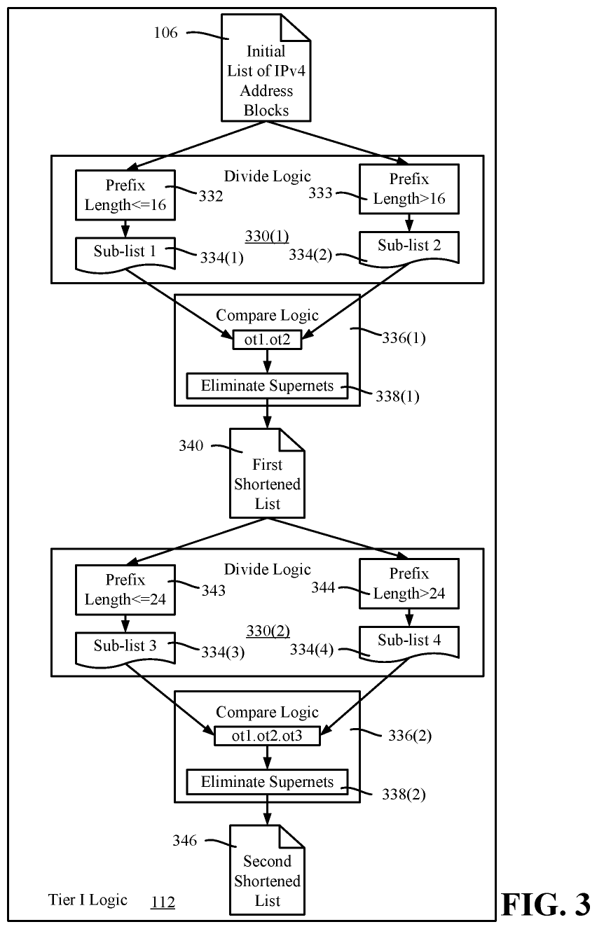

In general, two conditions enable the identification of supernets from the original list by the tier I logic 112. First, any IPv4 address blocks with a prefix length less than or equal to sixteen are supernets of other IPv4 address blocks that have the same first two octet (ot1.ot2) combination with a prefix length larger than sixteen. Second, any IPv4 address blocks with prefix length less than or equal to twenty-four are supernets of other IPv4 address blocks that have the same first three octet (ot1.ot2.ot3) combination with prefix length larger than twenty-four. To shorten the initial IPv4 address block dataset 106 (FIG. 1), identified supernets are eliminated so as to reduce the computational cost for tier II logic 116. Additional details of the tier I logic 112 are described herein with reference to FIGS. 3, 5 and 6.

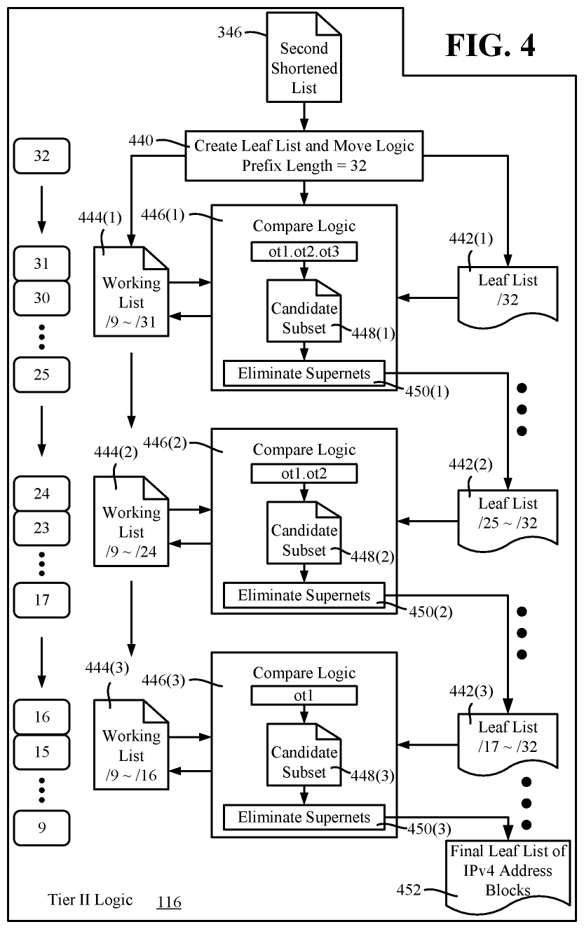

With the reduced dataset following tier I processing, the tier II logic 116 operates to identify conditions for establishing candidate (possible) supernet/subnet relationship within each octet. Those identified candidates that are confirmed to be supernets are removed, leaving only subnets that are not supernets to any other subnet, that is, the leaf nodes in the IPv4 hierarchy. Additional details of the tier II logic 116 are described herein with reference to FIGS. 4 and 7-9.

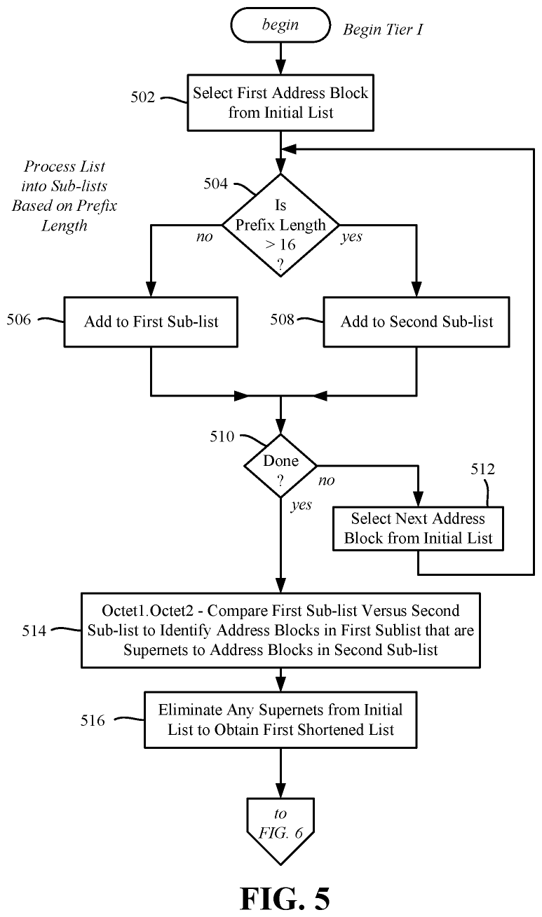

FIG. 3 is a block diagram showing one example of how the tier I logic 112 can be implemented. In general, starting with the initial dataset (e.g., list) of IPv4 address blocks, a first instance of divide logic 330(1) of the tier I logic 112 divides, based on the prefix lengths of the IPv4 address blocks being less than or equal to sixteen (block 332) or greater than sixteen (block 333), the IPv4 address blocks into a first sub-list 334(1) and a second sub-list 334(2). As is understood, this is based on the first two octets. This dividing part of the logic is also represented by operations 502, 504, 506, 508, 510 and 512 of FIG. 5.

Returning to FIG. 3, once divided into the first sub-list 334(1) and the second sub-list 334(2), a first instance of compare logic 336 (1) looks for supernet and subnet relationships between the IPv4 address blocks the first sub-list 334(1) and a second sub-list 334(2). That is, the compare logic 336(1) looks for any supernets in the first sub-list 334(1) having a subnet in the second sub-list 334(2). Any supernets are eliminated via block 338(1). The compare operation and supernet elimination operation are also shown in FIG. 5 via operations 514 and 516, respectively.

To summarize, to identify supernets from the original list any IPv4 address blocks with a prefix length less than or equal to 16 are supernets of other IPv4 address blocks that have the same ot1.ot2 with prefix length larger than 16. To this end, the divide logic 330(1) breaks the initial list into the first sub-list 334(1) with IPv4 address blocks prefix length entries of /9, /10, . . . /16, and a second sub-list list 334(2) with IPv4 address blocks prefix length entries of /17, /18, . . . /32. The compare logic 336(1) compares the first two octet “ot1.ot2” combination between the two sub-lists list 334(1) and list 334(2) to identify any IPv4 address blocks in the first sub-list list 334(2) that are supernets of other IPv4 address blocks in the second sub-list list 334(2). The identified supernets are removed (block 338(1) resulting in a first shortened list 340.

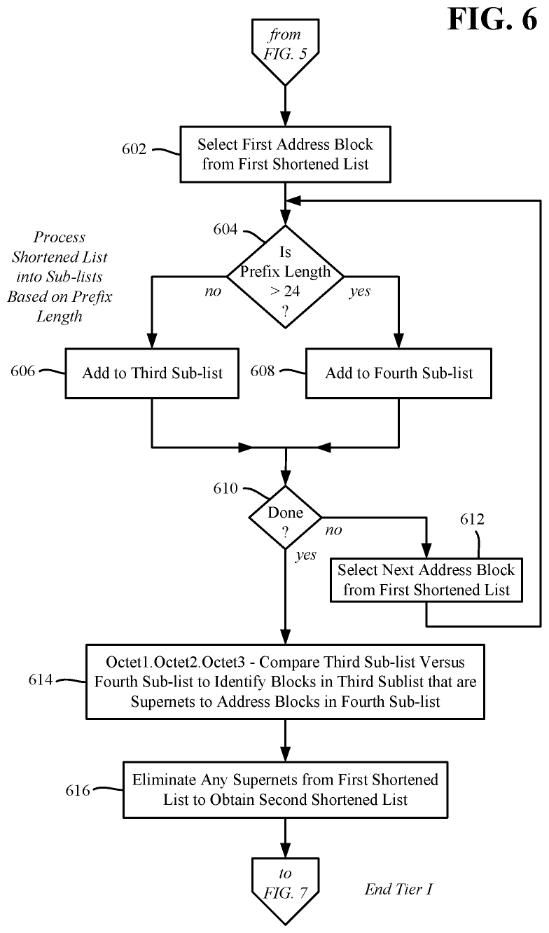

A second instance of the divide logic 330(2) operates on the first shortened list 340 in a similar manner, but with the first three octets (ot1.ot2.ot3). To this end, the divide logic 330(2) separates the entries in the shortened list 340 into a third sub-list 334(3) and a fourth sub-list 334(4) based on the prefix lengths of the IPv4 address blocks being less than or equal to twenty-four (block 343) or greater than twenty-four (block 344). In this way, the third sub-list 334(3) has IPv4 address block entries with prefix lengths of /9, /10, . . . /24, and the fourth sub-list 334(4) has IPv4 address blocks with prefix length entries of /25, /26, . . . /32. This second instance of the dividing part of the logic is also represented by operations 602, 604, 606, 608, 610 and 612 of FIG. 6.

Any IPv4 address blocks with a prefix length less than or equal to 24 are supernets of other IPv4 address blocks that have the same three octet combination (ot1.ot2.ot3) with prefix length larger than 24. Thus, as shown in FIG. 3, once divided into the third sub-list 334(3) and the fourth sub-list 334(4), a second instance of the compare logic 336(2) looks for supernet and subnet relationships between the IPv4 address blocks the third sub-list 334(3) and the fourth sub-list 334(4). That is, the compare logic 336(2) looks for any supernets in the third sub-list 334(3) having a subnet in the fourth sub-list 334(4). Any supernets are eliminated via block 338(2), resulting in a second shortened list 346. The compare operation and supernet elimination operation are also shown in FIG. 6 via operations 614 and 616, respectively. At this point, the tier I logic 112 can be considered complete.

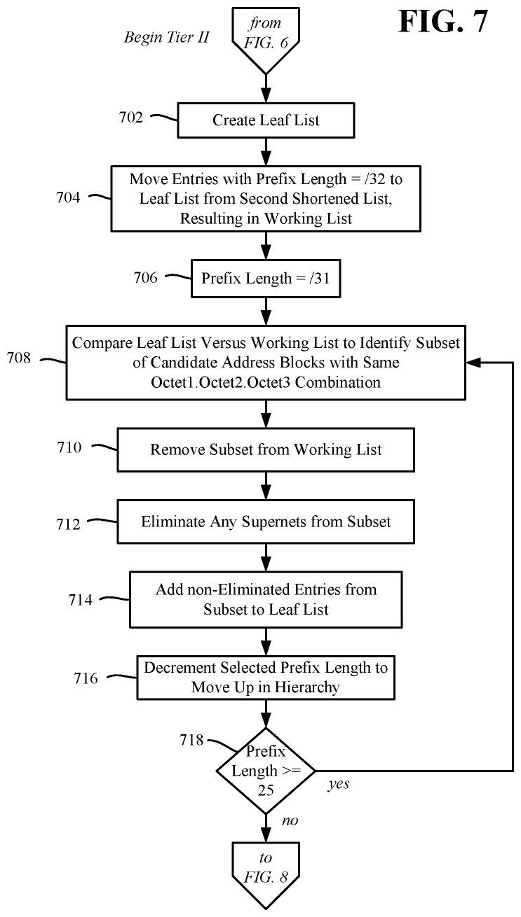

An example implementation of the tier II logic 116 is shown in the block diagram of FIG. 4 and the flow diagrams of FIGS. 7-9. Logic 440 creates a leaf dataset/data structure, e.g., a list 442(1) in a first state, which is also shown via operation 702 of FIG. 7. Because with an IPv4 address the smallest block length is thirty-two (32), any /32 address blocks are leaves, and are moved to the leaf list 442(1). This results in a working list 444(1) (FIG. 4) in a first state, containing IPv4 address blocks with prefix lengths from /31 to /9. As will be seen, a hierarchical bottom-up approach is used, where identification and confirmation processes operate against the leaf list in various states, e.g., 442(1)-442(3), starting from any IPv4 address blocks with prefix length /31, go up to prefix length /9. The confirmed leaf blocks are added to the leaf list instance after each iteration, and identified supernets are removed from the working list.

Turning to identification, for each prefix length greater than twenty-four, (P>24), only the subset of IPv4 address blocks of prefix length (P−1) can be candidate supernets of IPv4 address blocks of /P that have the same three octet (ot1.ot2.ot3) combination. Thus, once the candidate subset 448(1) is identified, the only check needs to be made among the identified candidates subset 448(1) versus the leaf list. Identified supernets are removed (block 450(1) from the subset 448(1). Those remaining in the subset are moved (appended to) the leaf list 442(1).

The compare and eliminate operations for the three octet (ot1.ot2.ot3) combination are shown in FIG. 7, with the operations being iterative starting from prefix length /31 (operation 706). Operation 708 compares the leaf list versus the working list to identify the subset of candidate address blocks with same octet1.octet2.octet3 combination. Operation 710 removes the subset from the working list (the entries can be moved from the working list to the subset), producing a reduced working list. Operation 712 eliminates any of the actual supernets from the candidate subset. Operation 714 adds (e.g., moves) the non-eliminated entries from the subset to the leaf list.

Operations 716 decrements the prefix length to move up in the hierarchy. Operation 718 repeats the process until the prefix length equals twenty-four. At this point, the three octet combinations have been handled.

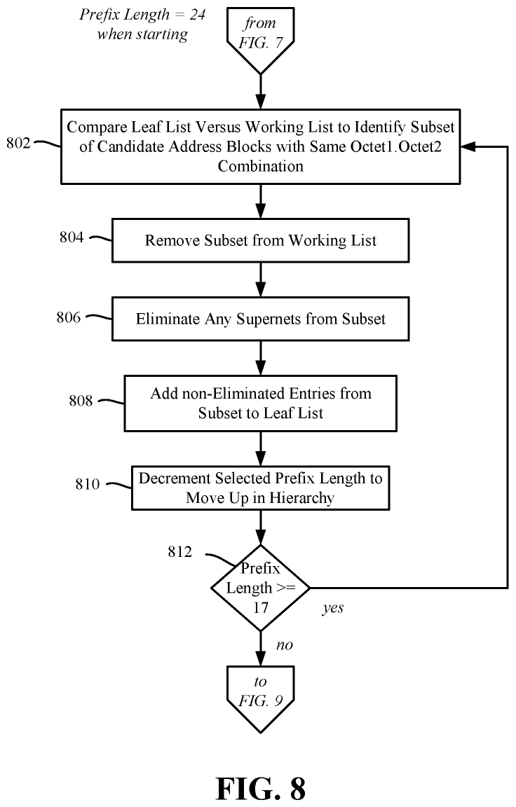

For each prefix length between twenty-four and sixteen (24<=P>16), only IPv4 address blocks of prefix length (P−1) can be supernets of IPv4 address blocks of /P that have the same two octet (ot1.ot2) combination. The operations, shown in FIG. 8, are generally the same as in FIG. 7 (and not described again for purposes of brevity), except that in FIG. 8 the prefix lengths are decremented from twenty-four to sixteen.

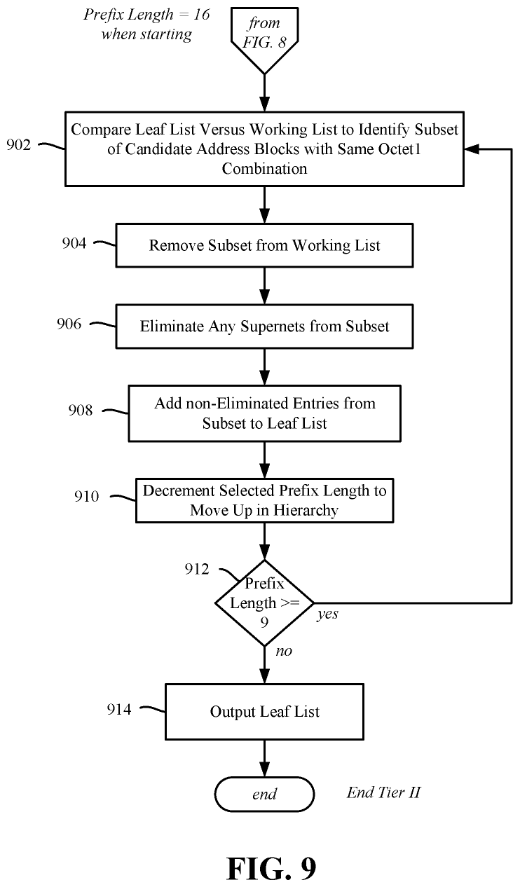

Similarly, FIG. 9 shows the operations for handling prefixes from sixteen to nine, that is, for each prefix length P>9, only IPv4 address blocks of prefix length (P−1) can be supernets of IPv4 address blocks of /P that have the same octet (oil). The supernets are similarly removed. Once operation 912 completes, the final leaf list 452 (FIG. 4) is output at operation 914, e.g., written to a file.

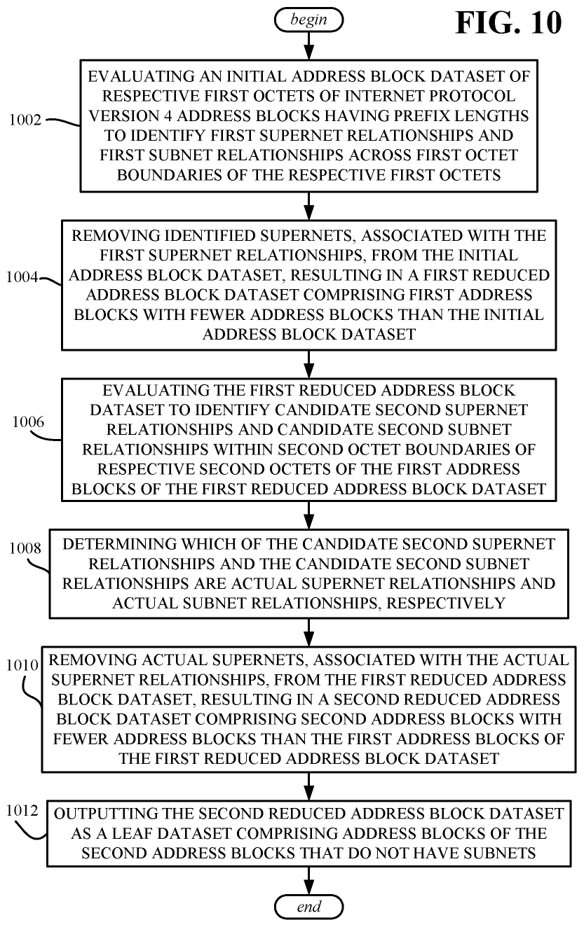

One or more aspects are represented in FIG. 10, and can comprise example operations, such as of a processor and a memory that stores executable instructions or components, that, when executed by the processor, facilitate performance of the example operations. Operation 1002 represents evaluating an initial address block dataset of respective first octets of Internet Protocol version 4 address blocks having prefix lengths to identify first supernet relationships and first subnet relationships across first octet boundaries of the respective first octets. Operation 1004 represents removing identified supernets, associated with the first supernet relationships, from the initial address block dataset, resulting in a first reduced address block dataset comprising first address blocks with fewer address blocks than the initial address block dataset. Operation 1006 represents evaluating the first reduced address block dataset to identify candidate second supernet relationships and candidate second subnet relationships within second octet boundaries of respective second octets of the first address blocks of the first reduced address block dataset. Operation 1008 represents determining which of the candidate second supernet relationships and the candidate second subnet relationships are actual supernet relationships and actual subnet relationships, respectively. Operation 1010 represents removing actual supernets, associated with the actual supernet relationships, from the first reduced address block dataset, resulting in a second reduced address block dataset comprising second address blocks with fewer address blocks than the first address blocks of the first reduced address block dataset. Operation 1012 represents outputting the second reduced address block dataset as a leaf dataset comprising address blocks of the second address blocks that do not have subnets.

Evaluating the initial address block dataset can comprise dividing the initial address block dataset into a first sub-list and a second sub-list based on a defined prefix length of the Internet Protocol version 4 address blocks in the initial address block dataset, and identifying first blocks in the first sub-list that are supernet address blocks of second blocks in the second sub-list. The defined prefix length can be sixteen.

The defined prefix length can be a first defined prefix length, and removing the identified supernets from the initial address block dataset can comprise removing the first blocks in the first sub-list that are the supernet address blocks of the second blocks in the second sub-list, resulting in a working address block dataset that contains fewer address blocks than the initial address block dataset, dividing the working address block dataset into a third sub-list and a fourth sub-list based on a second defined prefix length of remaining Internet Protocol version 4 address blocks in the working address block dataset, identifying third blocks in the third sub-list that are supernet address blocks of fourth blocks in the fourth sub-list, and wherein removing the identified supernets further comprises removing the third blocks in the third sub-list that are the supernet address blocks of the fourth blocks in the fourth sub-list to obtain the first reduced address block dataset. The second defined prefix length can be twenty-four.

Further operations can comprise creating the leaf dataset, and moving ones of the first address blocks with associated prefix lengths equal to thirty-two from the first reduced address block dataset to the leaf dataset.

Further operations can comprise moving any of the second address blocks with associated prefix lengths equal to thirty-two from the second reduced address block list to the leaf dataset, resulting in a working dataset that comprises no more than the second address blocks of the second reduced address block list, and evaluating the first reduced address block list to identify the candidate second supernet relationships and the candidate second subnet relationships within the second octet boundaries can comprise repeating, for associated prefix lengths from thirty-one to nine in descending prefix length order, identifying a subset of candidate address blocks in the working dataset, removing the candidate address blocks in the subset of candidate address blocks from the working dataset, removing any of the candidate address blocks from the subset that are supernets of third address blocks in the leaf dataset, and adding any remaining address blocks in the subset to the leaf dataset.

Further operations can comprise moving any of the second address blocks with prefix lengths equal to thirty-two from the second reduced address block list to the leaf dataset, resulting in a working dataset that comprises no more than the second address blocks than the second reduced address block list, and wherein evaluating the first reduced address block list to identify the candidate second supernet relationships and the candidate second subnet relationships within the second octet boundaries can comprise repeating, for a first range of associated prefix lengths of the first address blocks from thirty-one to twenty-five in descending prefix length order: comparing first ones of the first address blocks that share a first three octets combination between the leaf dataset and the working dataset to identify a first subset of candidate address blocks in the working dataset that share a first three octets combination, removing the candidate address blocks in the first subset of candidate address blocks from the working dataset, removing any of the candidate address blocks from the first subset that are supernets of third address blocks in the leaf dataset, and adding any remaining address blocks in the first subset to the leaf dataset, repeating, for a second range of associated prefix lengths of the first address blocks from twenty-four to seventeen in descending prefix length order: comparing second ones of the first address blocks that share a first two octets combination between the leaf dataset and the working dataset to identify a second subset of candidate address blocks in the working dataset that share a first two octets combination, removing the candidate address blocks in the second subset of candidate address blocks from the working dataset, removing any of the candidate address blocks from the second subset that are supernets of the third address blocks in the leaf dataset, and adding any remaining address blocks from the second subset to the leaf dataset; and repeating, for a third range of associated prefix lengths of the first address blocks from sixteen to nine in descending prefix length order: comparing third ones of the first address blocks that share a first octet between the leaf dataset and the working dataset to identify a third subset of candidate address blocks in the working dataset that share a first octet, removing the candidate address blocks in the third subset of candidate address blocks from the working dataset, removing any of the candidate address blocks from the third subset that are supernets of the third address blocks in the leaf dataset, and adding any remaining address blocks from the third subset to the leaf dataset.

Further operations can comprise obtaining the initial address block dataset from a network snapshot of an origin block and subnets of the origin block.

Further operations can comprise obtaining the initial address block dataset based on information exported from route advertisements of network routers.

The leaf dataset can comprise a user address block dedicated to a customer identity associated with a customer.

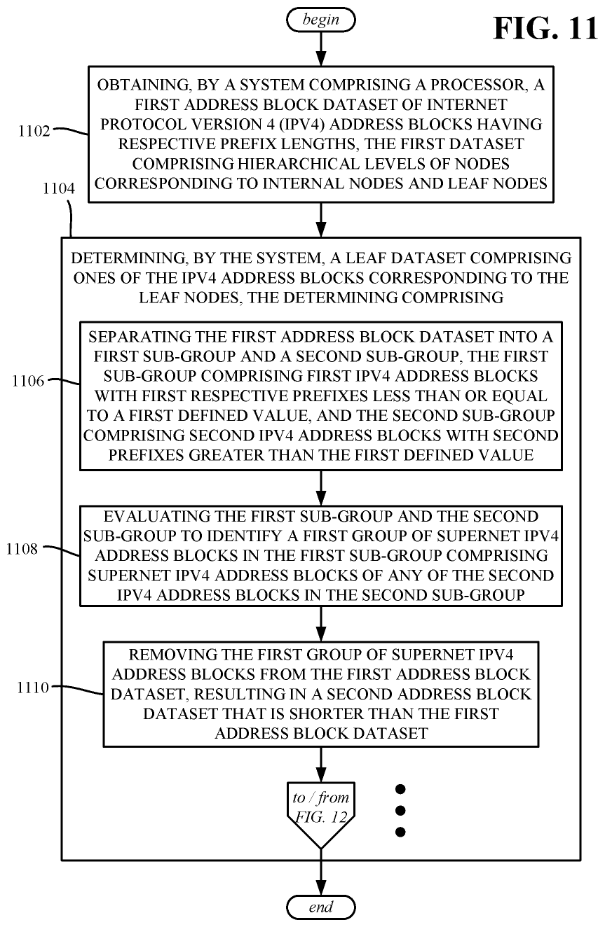

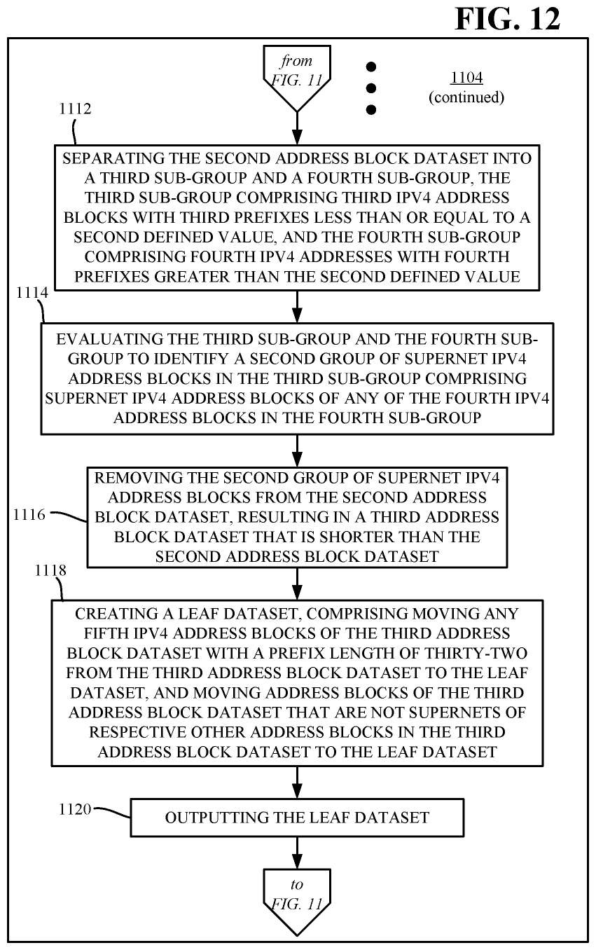

One or more aspects are represented in FIGS. 11 and 12, and can comprise example operations, such as of a method. Operation 1102 represents obtaining, by a system comprising a processor, a first address block dataset of Internet Protocol version 4 (IPv4) address blocks having respective prefix lengths, the first dataset comprising hierarchical levels of nodes corresponding to internal nodes and leaf nodes. Operation 1104 represents determining, by the system, a leaf dataset comprising ones of the IPv4 address blocks corresponding to the leaf nodes. The determining can comprise separating the first block dataset into a first sub-group and a second sub-group, the first sub-group comprising first IPv4 address blocks with first respective prefixes less than or equal to a first defined value, and the second sub-group comprising second IPv4 address blocks with second prefixes greater than the first defined value (operation 1106), and evaluating the first sub-group and the second sub-group to identify a first group of supernet IPv4 address blocks in the first sub-group comprising supernet IPv4 address blocks of any of the second IPv4 address blocks in the second sub-group; (operation 1108). The determining can further comprise removing the first group of supernet IPv4 address blocks from the first address block dataset, resulting in a second address block dataset that is shorter than the first address block dataset (operation 1110), separating the second address block dataset into a third sub-group and a fourth sub-group, the third sub-group comprising third IPv4 address blocks with third prefixes less than or equal to a second defined value, and the fourth sub-group comprising fourth IPv4 address blocks with fourth prefixes greater than the second defined value (operation 1112, FIG. 12), evaluating the third sub-group and the fourth sub-group to identify a second group of supernet IPv4 address blocks in the third sub-group comprising supernet IPv4 address blocks of any of the fourth IPv4 address blocks in the fourth sub-group, (operation 1114), removing the second group of supernet IPv4 address blocks from the second address block dataset, resulting in a third address block dataset that is shorter than the second address block dataset (operation 1116), creating a leaf dataset, comprising moving any fifth IPv4 address blocks of the third address block dataset with a prefix length of thirty-two from the third address block dataset to the leaf dataset, and moving address blocks of the third address block dataset that are not supernets of respective other address blocks in the third address block dataset to the leaf dataset (operation 1118), and outputting the leaf dataset (operation 1120).

Obtaining the first address block dataset of the IPv4 address blocks can comprise obtaining a snapshot of current network data.

The first defined value can be sixteen and wherein the second defined value can be twenty-four.

Moving any of the fifth IPv4 address blocks with the prefix length of thirty-two from the third address block dataset to the leaf dataset can create a working dataset, and moving the address blocks that are not supernets of the other address blocks in the third address block dataset to the leaf dataset can comprise repeating, for prefix lengths from thirty-one to nine in descending prefix length order: identifying a subset of candidate address blocks in the working dataset, removing the candidate address blocks in the subset from the working dataset, removing any of the candidate address blocks from the subset that are supernets of address blocks in the leaf dataset, and adding any remaining address blocks in the subset to the leaf dataset.

Moving any of the fifth IPv4 address blocks with the prefix length of thirty-two from the third address block dataset to the leaf dataset can create a working dataset, and moving the address blocks that are not supernets of the other address blocks in the third address block dataset to the leaf dataset can comprise repeating, for a first range of prefix lengths from thirty-one to twenty-five in descending prefix length order: comparing first address blocks that share a first three octets combination between the leaf dataset and the working dataset to identify a first subset of candidate address blocks in the working dataset that share a first three octets combination, removing the candidate address blocks in the first subset of candidate address blocks from the working dataset, removing any of the candidate address blocks from the first subset that are supernets of address blocks in the leaf dataset, and adding any remaining address blocks in the first subset to the leaf dataset, repeating, for a second range of prefix lengths from twenty-four to seventeen in descending prefix length order: comparing second address blocks that share a first two octets combination between the leaf dataset and the working dataset to identify a second subset of candidate address blocks in the working dataset that share a first two octets combination, removing the candidate address blocks in the second subset of candidate address blocks from the working dataset, removing any of the candidate address blocks from the second subset that are supernets of the address blocks in the leaf dataset, and adding any remaining address blocks from the second subset to the leaf dataset, and repeating, for a third range of prefix lengths from sixteen to nine in descending prefix length order: comparing third address blocks that share a first octet between the leaf dataset and the working dataset to identify a third subset of candidate address blocks in the working dataset that share a first octet, removing the candidate address blocks in the third subset of candidate address blocks from the working dataset, removing any of the candidate address blocks from the third subset that are supernets of the address blocks in the leaf dataset, and adding any remaining address blocks from the third subset to the leaf dataset.

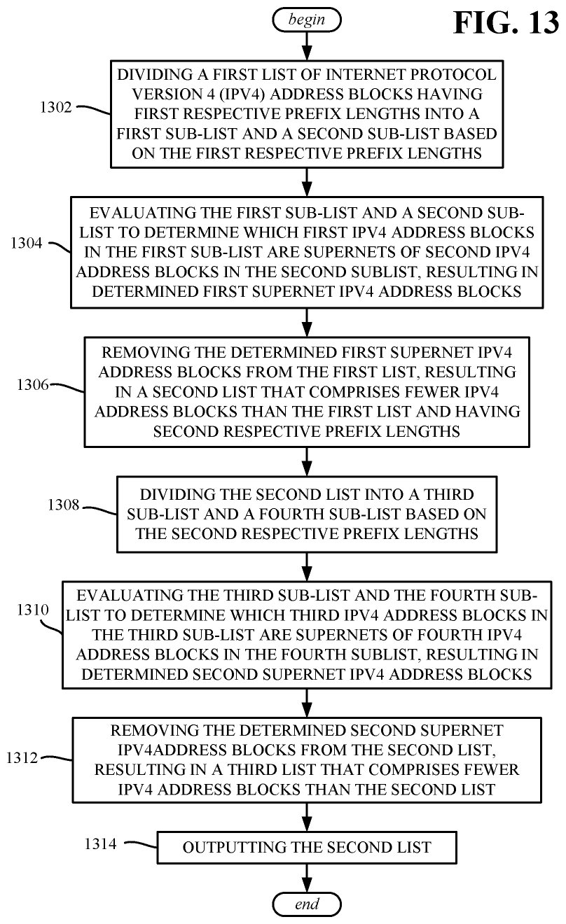

One or more aspects are represented in FIG. 13, and can comprise a machine-readable medium, comprising executable instructions that, when executed by a processor, facilitate performance of example operations. Operation 1302 represents dividing a first list of Internet Protocol version 4 (IPv4) address blocks having first respective prefix lengths into a first sub-list and a second sub-list based on the first respective prefix lengths. Operation 1304 represents evaluating the first sub-list and a second sub-list to determine which first IPv4 address blocks in the first sub-list are supernets of second IPv4 address blocks in the second sublist, resulting in determined first supernet IPv4 address blocks. Operation 1306 represents removing the determined first supernet IPv4 address blocks from the first list, resulting in a second list that comprises fewer IPv4 address blocks than the first list and having second respective prefix lengths. Operation 1308 represents dividing the second list into a third sub-list and a fourth sub-list based on the second respective prefix lengths. Operation 1310 represents evaluating the third sub-list and the fourth sub-list to determine which third IPv4 address blocks in the third sub-list are supernets of fourth IPv4 address blocks in the fourth sublist, resulting in determined second supernet IPv4 address blocks. Operation 1312 represents removing the determined second supernet IPv4 address blocks from the second list, resulting in a third list that comprises fewer IPv4 address blocks than the second list. Operation 1314 represents outputting the second list.

Further operations can comprise moving any IPv4 address block from the second list with a prefix length of thirty-two to a leaf list, resulting in a working list that has a same number of IPv4 address blocks as the second list or has fewer IPv4 address blocks than the second list. Further operations can comprise moving address blocks that are not supernets of other respective address blocks in the working list to the leaf list, comprising repeating, for prefix lengths of the IPv4 address blocks of the second list from thirty-one to nine in descending prefix length order: identifying a subset of candidate address blocks in the working list, removing the candidate address blocks in the subset of candidate address blocks from the working list, removing any of the candidate address blocks from the subset that are supernets of address blocks in the leaf list, adding any remaining address blocks in the subset to the leaf list, and outputting the leaf list.

Further operations can comprise moving address blocks that are not supernets of other respective address blocks in the working list to the leaf list, comprising: repeating, for a first range of prefix lengths of the IPv4 address blocks of the second list from thirty-one to twenty-five in descending prefix length order: comparing first address blocks that share a first three octets combination between the leaf list and the working dataset to identify a first subset of candidate address blocks in the working dataset that share a first three octets combination, removing the candidate address blocks in the first subset of candidate address blocks from the working dataset, removing any of the candidate address blocks from the first subset that are supernets of address blocks in the leaf list, and adding any remaining address blocks in the first subset to the leaf list, repeating, for a second range of prefix lengths of the IPv4 address blocks of the second list from twenty-four to seventeen in descending prefix length order: comparing second address blocks that share a first two octets combination between the leaf list and the working dataset to identify a second subset of candidate address blocks in the working dataset that share a first two octets combination, removing the candidate address blocks in the second subset of candidate address blocks from the working dataset, removing any of the candidate address blocks from the second subset that are supernets of the address blocks in the leaf list, and adding any remaining address blocks from the second subset to the leaf list, and repeating, for a third range of prefix lengths of the IPv4 address blocks of the second list from sixteen to nine in descending prefix length order: comparing third address blocks that share a first octet between the leaf list and the working dataset to identify a third subset of candidate address blocks in the working dataset that share a first octet, removing the candidate address blocks in the third subset of candidate address blocks from the working dataset, removing any of the candidate address blocks from the third subset that are supernets of the address blocks in the leaf list, and adding any remaining address blocks from the third subset to the leaf list; and outputting the leaf list.

As can be seen, the technology described herein facilitates IPv4 address discovery which is a valuable building block that allows ISPs to efficiently discover IPv4 address blocks to manage, plan, and optimize their network and services in a timely manner. The technology described herein allows ISPs to efficiently manage valuable IPv4 address blocks, which are becoming scarcer, by knowing where address blocks are, which are free for future use, how big those block sizes are, and potential implications of using those free blocks. The technology described herein can perform this task efficiently by parsing through a large IPv4 block list out of route advertisements.

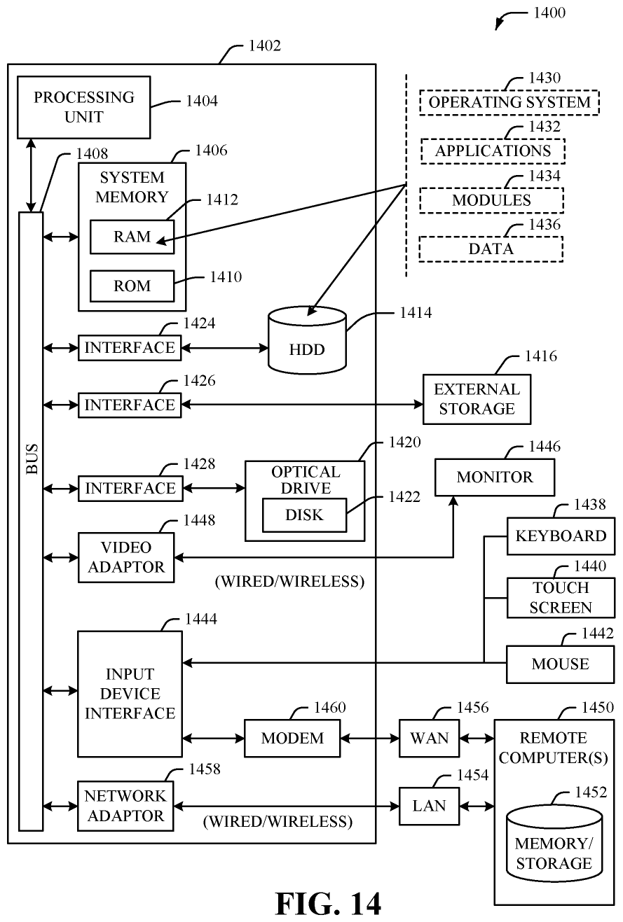

In order to provide additional context for various embodiments described herein, FIG. 14 and the following discussion are intended to provide a brief, general description of a suitable computing environment 1400 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments of the aspects described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a non-volatile memory such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and an optical disk drive 1420 (e.g., which can read or write from a CD-ROM disc, a DVD, a BD, etc.). While the internal HDD 1414 is illustrated as located within the computer 1402, the internal HDD 1414 can also be configured for external use in a suitable chassis (not shown). Additionally, while not shown in environment 1400, a solid state drive (SSD), non-volatile memory and other storage technology could be used in addition to, or in place of, an HDD 1414, and can be internal or external. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE) 1294 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally include emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can include one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enabled with a security module, such as a trusted processing module (TPM). For instance with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1294 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are example and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 8 GHz radio bands, at an 14 Mbps (802.11b) or 84 Mbps (802.11a) data rate, for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. In addition, memory components or memory elements can be removable or stationary. Moreover, memory can be internal or external to a device or component, or removable or stationary. Memory can include various types of media that are readable by a computer, such as hard-disc drives, zip drives, magnetic cassettes, flash memory cards or other types of memory cards, cartridges, or the like.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to include, without being limited, these and any other suitable types of memory.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated example aspects of the embodiments. In this regard, it will also be recognized that the embodiments include a system as well as a computer-readable medium having computer-executable instructions for performing the acts and/or events of the various methods.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, solid state drive (SSD) or other solid-state storage technology, compact disk read only memory (CD ROM), digital versatile disk (DVD), Blu-ray disc or other optical disk storage, magnetic cassettes, magnetic tape, magnetic disk storage or other magnetic storage devices or other tangible and/or non-transitory media which can be used to store desired information.

In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communications media include wired media, such as a wired network or direct-wired connection, and wireless media such as acoustic, RF, infrared and other wireless media

Further, terms like “user equipment,” “user device,” “mobile device,” “mobile,” station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the claims below.

What is claimed is:

1. A system, comprising:
a processor; and
a memory that stores executable instructions which, when executed by the processor of the system, facilitate performance of operations, the operations comprising:
evaluating an initial address block dataset of respective first octets of Internet Protocol version 4 address blocks having prefix lengths to identify first supernet relationships and first subnet relationships across first octet boundaries of the respective first octets;
removing identified supernets, associated with the first supernet relationships, from the initial address block dataset, resulting in a first reduced address block dataset comprising first address blocks with fewer address blocks than the initial address block dataset;
evaluating the first reduced address block dataset to identify candidate second supernet relationships and candidate second subnet relationships within second octet boundaries of respective second octets of the first address blocks of the first reduced address block dataset;
determining which of the candidate second supernet relationships and the candidate second subnet relationships are actual supernet relationships and actual subnet relationships, respectively;
removing actual supernets, associated with the actual supernet relationships, from the first reduced address block dataset, resulting in a second reduced address block dataset comprising second address blocks with fewer address blocks than the first address blocks of the first reduced address block dataset; and
outputting the second reduced address block dataset as a leaf dataset comprising address blocks of the second address blocks that do not have subnets.

2. The system of claim 1, wherein evaluating the initial address block dataset comprises dividing the initial address block dataset into a first sub-list and a second sub-list based on a defined prefix length of the Internet Protocol version 4 address blocks in the initial address block dataset, and identifying first blocks in the first sub-list that are supernet address blocks of second blocks in the second sub-list.

3. The system of claim 2, wherein the defined prefix length is sixteen.

4. The system of claim 2, wherein the defined prefix length is a first defined prefix length, and wherein removing the identified supernets from the initial address block dataset comprises removing the first blocks in the first sub-list that are the supernet address blocks of the second blocks in the second sub-list, resulting in a working address block dataset that contains fewer address blocks than the initial address block dataset, dividing the working address block dataset into a third sub-list and a fourth sub-list based on a second defined prefix length of remaining Internet Protocol version 4 address blocks in the working address block dataset, identifying third blocks in the third sub-list that are supernet address blocks of fourth blocks in the fourth sub-list, and wherein removing the identified supernets further comprises removing the third blocks in the third sub-list that are the supernet address blocks of the fourth blocks in the fourth sub-list to obtain the first reduced address block dataset.

5. The system of claim 4, wherein the second defined prefix length is twenty-four.

6. The system of claim 1, wherein the operations further comprise creating the leaf dataset, and moving ones of the first address blocks with associated prefix lengths equal to thirty-two from the first reduced address block dataset to the leaf dataset.

7. The system of claim 1, wherein the operations further comprise moving any of the second address blocks with associated prefix lengths equal to thirty-two from the second reduced address block list to the leaf dataset, resulting in a working dataset that comprises no more than the second address blocks of the second reduced address block list, and wherein evaluating the first reduced address block list to identify the candidate second supernet relationships and the candidate second subnet relationships within the second octet boundaries comprises repeating, for associated prefix lengths from thirty-one to nine in descending prefix length order, identifying a subset of candidate address blocks in the working dataset, removing the candidate address blocks in the subset of candidate address blocks from the working dataset, removing any of the candidate address blocks from the subset that are supernets of third address blocks in the leaf dataset, and adding any remaining address blocks in the subset to the leaf dataset.

8. The system of claim 1, wherein the operations further comprise moving any of the second address blocks with prefix lengths equal to thirty-two from the second reduced address block list to the leaf dataset, resulting in a working dataset that comprises no more than the second address blocks than the second reduced address block list, and wherein evaluating the first reduced address block list to identify the candidate second supernet relationships and the candidate second subnet relationships within the second octet boundaries comprises:
repeating, for a first range of associated prefix lengths of the first address blocks from thirty-one to twenty-five in descending prefix length order:
comparing first ones of the first address blocks that share a first three octets combination between the leaf dataset and the working dataset to identify a first subset of candidate address blocks in the working dataset that share a first three octets combination, removing the candidate address blocks in the first subset of candidate address blocks from the working dataset, removing any of the candidate address blocks from the first subset that are supernets of third address blocks in the leaf dataset, and adding any remaining address blocks in the first subset to the leaf dataset;
repeating, for a second range of associated prefix lengths of the first address blocks from twenty-four to seventeen in descending prefix length order:
comparing second ones of the first address blocks that share a first two octets combination between the leaf dataset and the working dataset to identify a second subset of candidate address blocks in the working dataset that share a first two octets combination, removing the candidate address blocks in the second subset of candidate address blocks from the working dataset, removing any of the candidate address blocks from the second subset that are supernets of the third address blocks in the leaf dataset, and adding any remaining address blocks from the second subset to the leaf dataset; and
repeating, for a third range of associated prefix lengths of the first address blocks from sixteen to nine in descending prefix length order:
comparing third ones of the first address blocks that share a first octet between the leaf dataset and the working dataset to identify a third subset of candidate address blocks in the working dataset that share a first octet, removing the candidate address blocks in the third subset of candidate address blocks from the working dataset, removing any of the candidate address blocks from the third subset that are supernets of the third address blocks in the leaf dataset, and adding any remaining address blocks from the third subset to the leaf dataset.

9. The system of claim 1, wherein the operations further comprise obtaining the initial address block dataset from a network snapshot of an origin block and subnets of the origin block.

10. The system of claim 1, wherein the operations further comprise obtaining the initial address block dataset based on information exported from route advertisements of network routers.

11. The system of claim 1, wherein the leaf dataset comprises a user address block dedicated to a customer identity associated with a customer.

12. A method, comprising:
obtaining, by a system comprising a processor, a first address block dataset of Internet Protocol version 4 (IPv4) address blocks having respective prefix lengths, the first dataset comprising hierarchical levels of nodes corresponding to internal nodes and leaf nodes; and
determining, by the system, a leaf dataset comprising ones of the IPv4 address blocks corresponding to the leaf nodes, the determining comprising:
separating the first address block dataset into a first sub-group and a second sub-group, the first sub-group comprising first IPv4 address blocks with first respective prefixes less than or equal to a first defined value, and the second sub-group comprising second IPv4 address blocks with second prefixes greater than the first defined value;
evaluating the first sub-group and the second sub-group to identify a first group of supernet IPv4 address blocks in the first sub-group comprising supernet IPv4 address blocks of any of the second IPv4 address blocks in the second sub-group;
removing the first group of supernet IPv4 address blocks from the first address block dataset, resulting in a second address block dataset that is shorter than the first address block dataset;
separating the second address block dataset into a third sub-group and a fourth sub-group, the third sub-group comprising third IPv4 address blocks with third prefixes less than or equal to a second defined value, and the fourth sub-group comprising fourth IPv4 address blocks with fourth prefixes greater than the second defined value;
evaluating the third sub-group and the fourth sub-group to identify a second group of supernet IPv4 address blocks in the third sub-group comprising supernet IPv4 address blocks of any of the fourth IPv4 address blocks in the fourth sub-group;
removing the second group of supernet IPv4 address blocks from the second address block dataset, resulting in a third address block dataset that is shorter than the second address block dataset;
creating a leaf dataset, comprising moving any fifth IPv4 address blocks of the third address block dataset with a prefix length of thirty-two from the third address block dataset to the leaf dataset, and moving address blocks of the third address block dataset that are not supernets of respective other address blocks in the third address block dataset to the leaf dataset; and
outputting the leaf dataset.

13. The method of claim 12, wherein obtaining the first address block dataset of the IPv4 address blocks comprises obtaining a snapshot of current network data.

14. The method of claim 12, wherein the first defined value is sixteen and wherein the second defined value is twenty-four.

15. The method of claim 12, wherein moving any of the fifth IPv4 address blocks with the prefix length of thirty-two from the third address block dataset to the leaf dataset creates a working dataset, and wherein moving the address blocks that are not supernets of the other address blocks in the third address block dataset to the leaf dataset comprises repeating, for prefix lengths from thirty-one to nine in descending prefix length order:
identifying a subset of candidate address blocks in the working dataset;
removing the candidate address blocks in the subset from the working dataset;
removing any of the candidate address blocks from the subset that are supernets of address blocks in the leaf dataset; and
adding any remaining address blocks in the subset to the leaf dataset.

16. The method of claim 12, wherein moving any of the fifth IPv4 address blocks with the prefix length of thirty-two from the third address block dataset to the leaf dataset creates a working dataset, and wherein moving the address blocks that are not supernets of the other address blocks in the third address block dataset to the leaf dataset comprises:
repeating, for a first range of prefix lengths from thirty-one to twenty-five in descending prefix length order:
comparing first address blocks that share a first three octets combination between the leaf dataset and the working dataset to identify a first subset of candidate address blocks in the working dataset that share a first three octets combination, removing the candidate address blocks in the first subset of candidate address blocks from the working dataset, removing any of the candidate address blocks from the first subset that are supernets of address blocks in the leaf dataset, and adding any remaining address blocks in the first subset to the leaf dataset;
repeating, for a second range of prefix lengths from twenty-four to seventeen in descending prefix length order:
comparing second address blocks that share a first two octets combination between the leaf dataset and the working dataset to identify a second subset of candidate address blocks in the working dataset that share a first two octets combination, removing the candidate address blocks in the second subset of candidate address blocks from the working dataset, removing any of the candidate address blocks from the second subset that are supernets of the address blocks in the leaf dataset, and adding any remaining address blocks from the second subset to the leaf dataset; and
repeating, for a third range of prefix lengths from sixteen to nine in descending prefix length order:
comparing third address blocks that share a first octet between the leaf dataset and the working dataset to identify a third subset of candidate address blocks in the working dataset that share a first octet, removing the candidate address blocks in the third subset of candidate address blocks from the working dataset, removing any of the candidate address blocks from the third subset that are supernets of the address blocks in the leaf dataset, and adding any remaining address blocks from the third subset to the leaf dataset.

17. A non-transitory machine-readable medium, comprising executable instructions that, when executed by a processor, facilitate performance of operations, the operations comprising:
dividing a first list of Internet Protocol version 4 (IPv4) address blocks having first respective prefix lengths into a first sub-list and a second sub-list based on the first respective prefix lengths;
evaluating the first sub-list and a second sub-list to determine which first IPv4 address blocks in the first sub-list are supernets of second IPv4 address blocks in the second sublist, resulting in determined first supernet IPv4 address blocks;
removing the determined first supernet IPv4 address blocks from the first list, resulting in a second list that comprises fewer IPv4 address blocks than the first list and having second respective prefix lengths;
dividing the second list into a third sub-list and a fourth sub-list based on the second respective prefix lengths;
evaluating the third sub-list and the fourth sub-list to determine which third IPv4 address blocks in the third sub-list are supernets of fourth IPv4 address blocks in the fourth sublist, resulting in determined second supernet IPv4 address blocks;
removing the determined second supernet IPv4 address blocks from the second list, resulting in a third list that comprises fewer IPv4 address blocks than the second list; and
outputting the second list.

18. The non-transitory machine-readable medium of claim 17, wherein the operations further comprise moving any IPv4 address block from the second list with a prefix length of thirty-two to a leaf list, resulting in a working list that has a same number of IPv4 address blocks as the second list or has fewer IPv4 address blocks than the second list.

19. The non-transitory machine-readable medium of claim 18, wherein the operations further comprise,
moving address blocks that are not supernets of other respective address blocks in the working list to the leaf list, comprising repeating, for prefix lengths of the IPv4 address blocks of the second list from thirty-one to nine in descending prefix length order:
identifying a subset of candidate address blocks in the working list;
removing the candidate address blocks in the subset of candidate address blocks from the working list;
removing any of the candidate address blocks from the subset that are supernets of address blocks in the leaf list; and
adding any remaining address blocks in the subset to the leaf list; and
outputting the leaf list.

20. The non-transitory machine-readable medium of claim 18, wherein the operations further comprise moving address blocks that are not supernets of other respective address blocks in the working list to the leaf list, comprising:
repeating, for a first range of prefix lengths of the IPv4 address blocks of the second list from thirty-one to twenty-five in descending prefix length order:
comparing first address blocks that share a first three octets combination between the leaf list and the working dataset to identify a first subset of candidate address blocks in the working dataset that share a first three octets combination, removing the candidate address blocks in the first subset of candidate address blocks from the working dataset, removing any of the candidate address blocks from the first subset that are supernets of address blocks in the leaf list, and adding any remaining address blocks in the first subset to the leaf list;
repeating, for a second range of prefix lengths of the IPv4 address blocks of the second list from twenty-four to seventeen in descending prefix length order:
comparing second address blocks that share a first two octets combination between the leaf list and the working dataset to identify a second subset of candidate address blocks in the working dataset that share a first two octets combination, removing the candidate address blocks in the second subset of candidate address blocks from the working dataset, removing any of the candidate address blocks from the second subset that are supernets of the address blocks in the leaf list, and adding any remaining address blocks from the second subset to the leaf list; and
repeating, for a third range of prefix lengths of the IPv4 address blocks of the second list from sixteen to nine in descending prefix length order:
comparing third address blocks that share a first octet between the leaf list and the working dataset to identify a third subset of candidate address blocks in the working dataset that share a first octet, removing the candidate address blocks in the third subset of candidate address blocks from the working dataset, removing any of the candidate address blocks from the third subset that are supernets of the address blocks in the leaf list, and adding any remaining address blocks from the third subset to the leaf list; and
outputting the leaf list.
